(19) United States
(12) Patent Application Publication
(10) Pub. No.: US 2010/0166546 A1
(43) Pub. Date: Jul. 1, 2010

(54) APPARATUSES, SYSTEMS, AND METHODS OF GAS TURBINE ENGINE COMPONENT INTERCONNECTION

(76) Inventors: Vance A. Mahan, Martinsville, IN (US); Daniel K. Morrison, Carmel, IN (US); Adam J. Morrison, Greenwood, IN (US)

Correspondence Address: KRIEG DEVAULT LLP, ONE INDIANA SQUARE, SUITE 2800, INDIANAPOLIS, IN, 46204-2079, US

(21) Appl. No.: 12/644,999

(22) Filed: Dec. 22, 2009

Related U.S. Application Data
(60) Provisional application No. 61/204,040, filed on Dec. 31, 2008.

(51) Int. Cl. F02C 7/00; B23P 11/00

(52) U.S. Cl. 415/199.4; 29/889.21

(57) ABSTRACT

One embodiment is an apparatus comprising a first rotational gas turbine engine component including first threads; a second rotational gas turbine engine component including second threads; the first threads and the second threads being mated; and the first rotational engine component being fastened to the second rotational engine component substantially only by the first threads and the second threads being mated. Other embodiments include unique apparatuses, systems, devices, and methods relating to gas turbine engine interconnection. Further exemplary embodiments, forms, objects, features, advantages, aspects, and benefits of the present invention are included in the following description, drawings, and claims.

### CROSS REFERENCE TO RELATED APPLICATIONS

The present application claims the benefit of U.S. Provisional Patent Application 61/204,040, filed Dec. 31, 2008, and is incorporated herein by reference.

### TECHNICAL FIELD

The technical field relates generally to gas turbine engines and more particularly to apparatuses, systems, and methods of gas turbine engine component interconnection.

### BACKGROUND

Gas turbine engines are an efficient source of energy and have proven useful to propel and power aircraft, for electricity generation, as well as for other uses. One aspect of gas turbine engines is that they include structures, systems, subsystems, parts, pieces, and other components which must be interconnected. Presently, apparatuses, systems and methods of gas turbine engine component interconnection often suffer from a number of disadvantages, limitations, and drawbacks, for example, those respecting weight, mass, complexity, ease of assembly or disassembly, part count, engine envelope, engine profile, and others. Thus, there is a need for the unique and inventive apparatuses, systems, and methods of gas turbine engine component interconnection.

### SUMMARY

One embodiment is a unique apparatus for gas turbine engine component interconnection. Other embodiments include unique apparatuses, systems, methods, and combinations of these and/or other aspects relating to gas turbine engines. Further embodiments, forms, objects, features, advantages, aspects, and benefits shall become apparent from the following description and drawings.

### BRIEF DESCRIPTION OF THE DRAWINGS

FIG. 1 is a schematic diagram of a gas turbine engine.

FIG. 2 is an illustrative view of interconnected gas turbine engine disks.

FIG. 3 is an illustrative view of several interconnected gas turbine engine components.

FIG. 4 is an illustrative view of interconnected gas turbine engine components including a lead in pilot.

FIG. 5 is an illustrative view of interconnected gas turbine engine components including a lead in pilot.

FIG. 6 is an illustrative view of interconnected shafts of a gas turbine engine.

### DETAILED DESCRIPTION

For purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

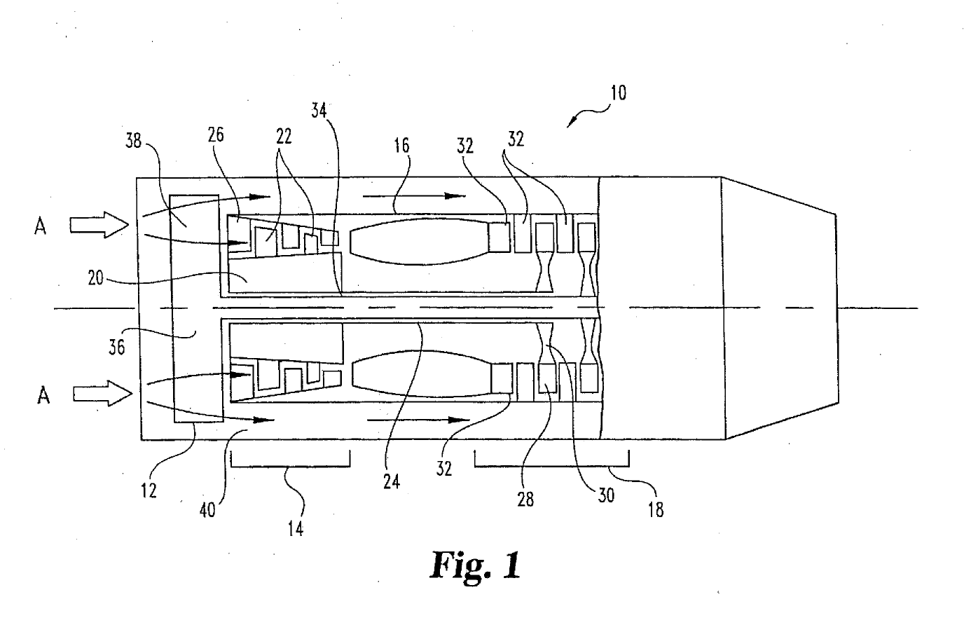

With reference to FIG. 1, there is illustrated a schematic representation of a gas turbine engine 10, which includes a fan section 12, a compressor section 14, a combustor section 16, and a turbine section 18 which are integrated together to provide an aircraft flight propulsion engine. This type of gas turbine engine is generally referred to as a turbo-fan. One alternate form of a gas turbine engine includes a compressor section, a combustor section and a turbine section which have been integrated together to produce an aircraft flight propulsion engine without the fan section. As used herein, the term aircraft includes helicopters, airplanes, missiles, spacecraft, unmanned space devices and any other substantially similar devices.

The compressor section 14 includes a rotor disk 20 having a plurality of compressor blades 22 coupled thereto. The rotor disk 20 is affixed to a shaft 24 that is rotatable within the gas turbine engine 10. A plurality of compressor vanes 26 are positioned within the compressor section 14 to direct the fluid flow relative to blades 22. Turbine section 18 includes a plurality of turbine blades 28 that are coupled to a rotor disk 30. The rotor disk 30 is affixed to the shaft 24, which is rotatable within the gas turbine engine 10. Energy extracted in the turbine section 18 from the hot gas exiting the combustor section 16 is transmitted through shaft 24 to drive the compressor section 14. Further, a plurality of turbine vanes 32 are positioned within the turbine section 18 to direct the hot gaseous flow stream exiting the combustor section 16.

As illustrated in the turbo-fan embodiment of FIG. 1, the turbine section 18 provides power to a fan shaft 34, which drives the fan section 12. The fan section 12 includes a fan 36 having a plurality of fan blades 38. Air enters the gas turbine engine 10 in the direction of arrows A and passes through the fan section 12 into the compressor section 14 and a bypass duct 40.

It is important to realize that there are multitudes of gas turbine engine configurations and types. For example, additional compressors and turbines could be added with intercoolers connecting between the compressors, reheat combustion chambers could be added between the turbines, and multiple compressor and turbine stages could be present. Furthermore, in addition to aircraft propulsion applications, gas turbine engines can be used for industrial applications, such as pumping sets for gas and oil transmission lines, electricity generation, and naval propulsion, to name a few examples. Apparatuses, systems and methods of component interconnection are applicable to all types of gas turbine engines and are not limited the exemplary embodiments shown and described herein. It should also be appreciated that the exemplary embodiments described herein include a number of rotational engine elements including, for example, shafts, disks, blades, compressor components, turbine components, gears, and fans, to name a few examples. Various embodiments of gas turbine engine component interconnection may include fewer or greater numbers of components, including as many as a complete gas turbine engine, or as few as two gas turbine engine components.

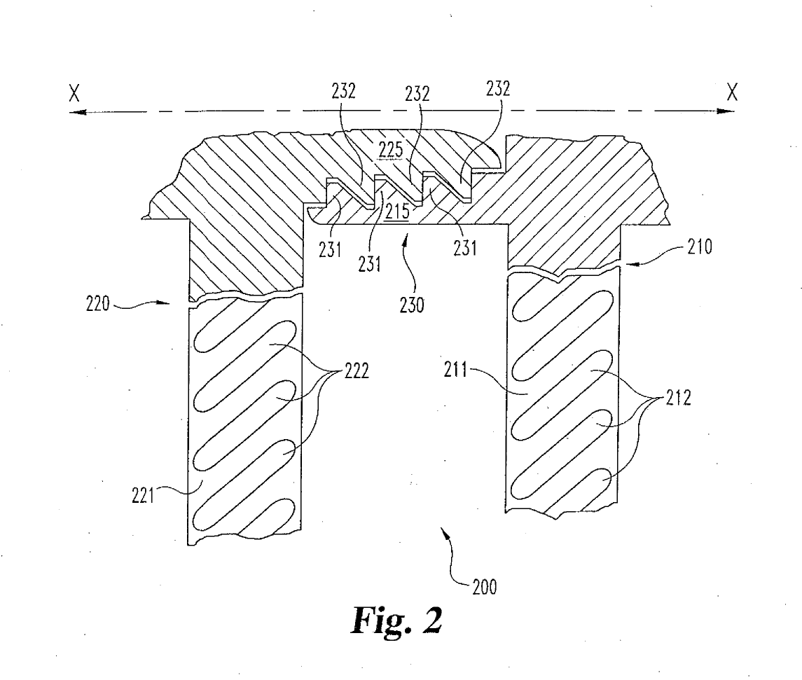

With reference to FIG. 2 there is an illustrative view of interconnected gas turbine engine compressor disks 200. Disk 210 includes exterior circumferential surface 211 with blades 212 extending therefrom, and disk 220 includes exterior circumferential surface 221 with blades 222 extending therefrom. Blades 212 are illustrated generically and could have a variety of angles, contours, designs, dimensions, geometries, shapes, sizes and other properties as would occur to those skilled in the art. This is also true of blades 222 which could have the same, similar or different characteristics as blades 212. During gas turbine engine operation disks 210 and 220 rotate about an axis illustrated as dashed line X.

As illustrated in FIG. 2, threaded interconnection 230 interconnects disks 210 and 220. Interconnection 230 is formed by the mating of threads 231 of member 215 and threads 232 of member 225. The mating of threads 231 and 232 alone is sufficient to maintain the interconnection of disks 210 and 220 during engine operation. Threads 231 and 232 can also be unmated to permit decoupling and separation of disks 210 and 220, for example, for maintenance, repair, or replacement of various gas turbine engine components. In one embodiment threads 231 and 232 are buttress threads; however, various embodiments contemplate the use of triangular threads, trapezoidal threads, single loading threads, dual loading threads, acme threads, witworth threads, as well as a variety of other threads, as well as combinations and variations of the foregoing. It is also contemplated, regardless of the particular thread configuration used, that the threads can be coated, partially coated, substantially coated, uncoated, partially uncoated, or substantially uncoated. Furthermore, it is contemplated that a variety of thread adhesives, sealants, lubricants, coatings, and curing agents could be used in connection with any of the foregoing threads.

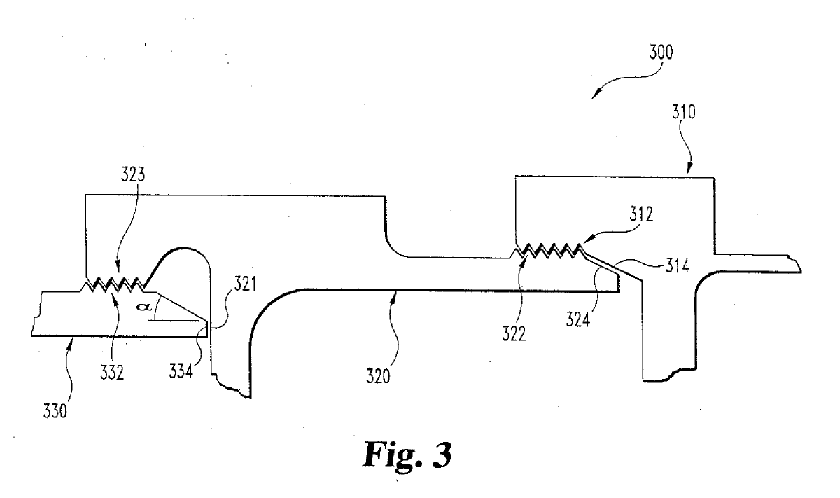

With reference to FIG. 3 there is shown one example of a gas turbine engine component assembly 300. Assembly 300 includes disks 310 and 320, and shaft 330. Disks 310 and 320 are interconnected by the mating of threads 312 and 322, and disk 320 and shaft 330 are interconnected by the mating of threads 323 and 332. These threads can include any of the types, configurations, variations, coatings and other thread features or properties mentioned above in connection with FIG. 2, and the same is also true of the other threads disclosed herein.

Also, as illustrated in FIG. 3, shaft 330 and compressor disk 320 include lead in pilots 334 and 324. Lead in pilots can facilitate mating of threads and interconnection of components by guiding components during interconnection. For example, angle α of lead in pilot 334 provides guidance for shaft 330 as it is introduced into disk 320 which helps to align threads 323 and 332 and facilitate their ability to mate. Lead in pilots can and also provide abutment between opposing surfaces, for example, lead in pilot 334 abuts opposing surface 321 when threads 323 and 332 are substantially completely mated. Similarly lead in pilot 324 abuts opposing surface 314 when threads 312 and 322 are substantially completely mated.

It should also be appreciated that various abutment configurations can provide a variety of additional features. For example, various abutment configurations can provide at least a partial seal between abutting structures, can stabilize abutting structures relative to one another, can provide some coupling of abutting structures, for example, due to friction or other forces between abutting structures, and can also provide force transfer between abutting structures. Nevertheless, it should be understood that even in embodiments which include each of the foregoing abutment features, the mating of threads alone is what maintains interconnection of engine components. Thus, even where lead in pilots 324 and 334 provide for abutment including all of the foregoing features, the mating of threads 312 and 332 is all that interconnects disks 310 and 320 and the mating of threads 323 and 332 is substantially all that interconnects disk 320 and shaft 330.

While FIG. 3 illustrates one interconnection of compressor disks 310 and 320 and a shaft 330, a variety of other interconnections are contemplated. For example, greater or fewer numbers of compressor disks could be used. Furthermore, greater numbers of shafts or other structure intermediate compression disks could be used. A variety of additional interconnections including interconnection of various components, structures, elements, and features noted above, and others are also contemplated.

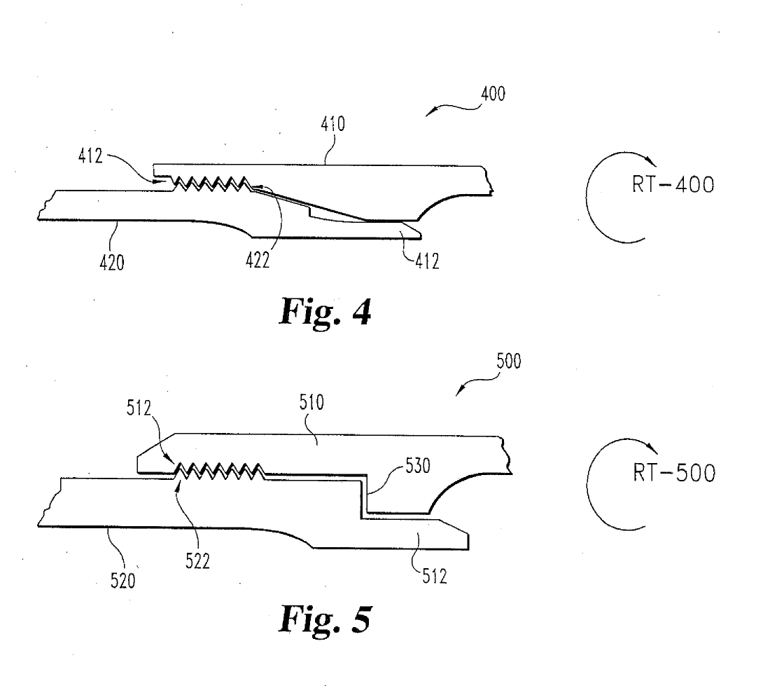

With reference to FIG. 4 there is shown assembly 400 in which rotatable elements 410 and 420 are interconnected by a pair of mating threads 412 and 422. These threads can include any of the types, configurations, variations, coatings and other features mentioned above in connection with FIG. 2. Elements 410 and 420 could be, for example, shafts, disks, other structures, or combinations of such structures. Element 410 includes a lead in pilot 412 which could have any of the features mentioned above. During engine operation, assembly 400 rotates in the direction indicated by Arrow RT-400. In this case, it is preferable for the treads 412 and 422 to tend to engage under such rotational conditions. Thus, during at least one state of operation, preferable the state inducing greatest or substantial force on the threaded interconnection, elements 410 and 420 tend toward engagement and not disengagement. In other embodiments the thread direction can be reversed. Furthermore, as mentioned above, threads 412 and 422 can also be dual loading or two way threads, which tend to engage regardless of the direction of rotation.

With reference to FIG. 5 there is shown assembly 500 which includes structures similar to assembly 400 as indicated by similar reference numerals incremental by 100. Additionally, assembly 500 includes abutment face 530 for contacting the opposite face of element 520. Abutment face 530 can include all of the abutment features mentioned above.

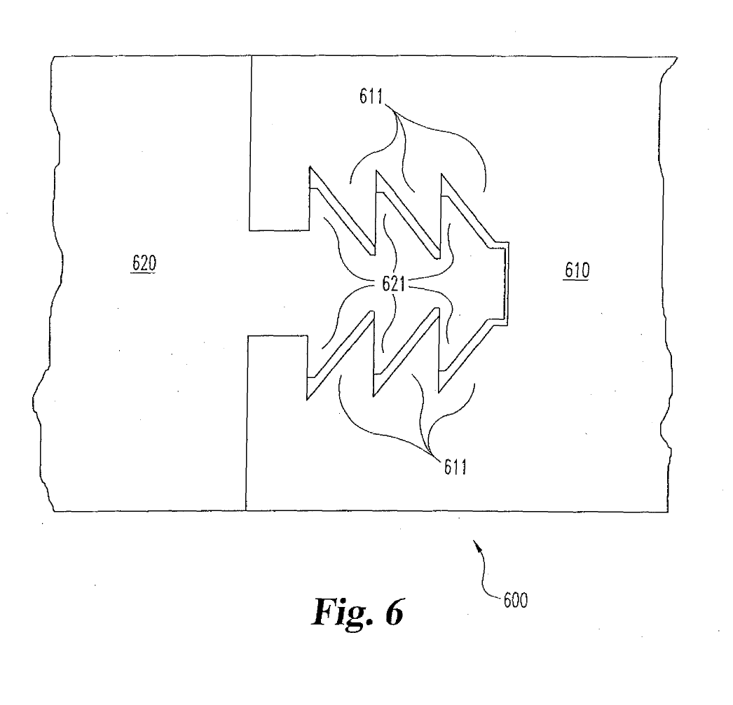

With reference to FIG. 6 there are shown interconnected rotational shafts 600 of a gas turbine engine. A first shaft 610 includes threads 610 and a second shaft 620 includes threads 621. Threads 611 and 621 are interconnected such that this interconnection alone is sufficient to maintain the interconnection of shafts 610 and 620 during engine operation.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An apparatus comprising:
a first rotational gas turbine engine component including first threads;
a second rotational gas turbine engine component including second threads;
the first threads and the second threads being mated; and
the first rotational engine component fastened to the second rotational engine component substantially only by the first threads and the second threads being mated.

2. The apparatus of claim 1 wherein the first rotational gas turbine engine component is a first disk and the second rotational gas turbine engine component is a second disk.

3. The apparatus of claim 2 wherein the disks are compressor disks.

4. The apparatus of claim 1 wherein the first rotational gas turbine engine component is a shaft and the second rotational gas turbine engine component is a disk.

5. The apparatus of claim 4 wherein the disk is a compressor disk

6. The apparatus of claim 1 wherein the first rotational gas turbine engine component is a first shaft and the second rotational gas turbine engine component is a second shaft.

7. The apparatus of claim 1 wherein the first threads and the second threads are buttress threads and at least one of the first rotational gas turbine engine component and the second rotational gas turbine engine component is a disk.

8. The apparatus of claim 1 wherein the first threads are coated threads and at least one of the first rotational gas turbine engine component and the second rotational gas turbine engine component is a shaft.

9. The apparatus of claim 1 wherein the first rotational gas turbine engine component includes a lead in pilot contacting the second gas turbine engine component.

10. The apparatus of claim 9 wherein lead in pilot contacting the second gas turbine engine component provides at least a partial seal between the first rotational gas turbine engine component and the second rotational gas turbine engine component.

11. A system comprising:
a gas turbine engine compressor disk including first threads;
a rotational gas turbine engine component including second threads;
wherein the first threads and second threads are interconnected; and
wherein substantially all that couples the gas turbine engine compressor disk and the rotational gas turbine engine component is the first threads and the second threads being interconnected.

12. The system of claim 11 further comprising a conical lead in pilot operable to form a seal intermediate the compressor disk and the rotational gas turbine engine component when the first threads and the second threads are substantially completely mated.

13. The system of claim 11 wherein the first and second threads are buttress threads.

14. The system of claim 11 wherein the rotational gas turbine engine component is a second compressor disk.

15. The system of claim 14 further comprising a third gas turbine engine compressor disk including third threads and wherein the second compressor disk further includes fourth threads; wherein the third threads and fourth threads are mated and said mating alone is sufficient to couple the second compressor disk and the third compressor disk during engine operation.

16. The system of claim 13 wherein the rotational gas turbine engine component is a rotational shaft.

17. A method comprising:
aligning a first gas turbine engine component and a second gas turbine engine component;
mating first threads and second threads to couple the first gas turbine engine component and the second gas turbine engine component; and
rotating the first gas turbine engine component and the second gas turbine engine component;
wherein said mating is essentially all that couples the first gas turbine engine component and the second gas turbine engine component.

18. The method of claim 17 wherein the aligning includes contacting a lead in pilot of the first gas turbine engine component to the second gas turbine engine component.

19. The method of claim 17 further comprising forming at least a partial seal between the first gas turbine engine component and the second gas turbine engine component using a lead in pilot.

20. The method of claim 17 wherein the first gas turbine engine component and the second gas turbine engine component are components of a complete gas turbine engine and further comprising starting the gas turbine engine and stopping the gas turbine engine.
